(19) United States
(12) Patent Application Publication
(10) Pub. No.: US 2026/0339095 A1
(43) Pub. Date: Oct. 29, 2026

(54) OBJECTIVE

(71) Applicant: Evident Corporation, Kamiina-gun (JP)

(72) Inventor: Kenichiro ABE, Kamiina-gun (JP)

(73) Assignee: Evident Corporation, Kamiina-gun (JP)

(21) Appl. No.: 19/551,633

(22) Filed: Feb. 27, 2026

(30) Foreign Application Priority Data
Apr. 25, 2025 (JP) 2025-073150

(51) Int. Cl. G02B 27/00; G02B 9/64; G02B 21/02; G02B 21/33; G02B 21/36

(52) U.S. Cl. CPC G02B 27/0068; G02B 9/64; G02B 21/02; G02B 21/33; G02B 21/361

(57) ABSTRACT

There is provided an objective including: in order from an object side, a first lens group that has positive refractive power and converts divergent light into convergent light; a second lens group that is moved along an optical axis and has negative refractive power; a third lens group that has two or more cemented surfaces; and a fourth lens group. The fourth lens group includes, in order from the object side, a meniscus lens component having a convex surface facing the object side, a lens component having a concave surface facing the object side, and a lens having a convex surface facing an image side.

### CROSS-REFERENCE TO RELATED APPLICATION

This application is based upon and claims the benefit of priority from prior Japanese Patent Application No. 2025-073150 filed Apr. 25, 2025, the entire contents of which are incorporated herein by this reference.

### FIELD

The disclosure of the present specification relates to an objective.

### BACKGROUND

In recent years, there is significant increase in the number of pixels of imaging elements, and in the field of microscopes, there are expectations for microscope devices that achieve both a wide field of view and high resolution and that are capable of performing observation and image acquisition. In such a background, an objective having a high numerical aperture (hereinafter referred to as NA), a long focal length, and a low magnification is desired.

In an objective having a high NA, the spherical aberration significantly varies with respect to changes in thickness of a cover glass, refractive index of a specimen, and refractive index of an immersion liquid. Therefore, in order to correct the variation of the spherical aberration, it is desirable to have a mechanism that moves a lens component in the objective along an optical axis. Such an objective is described, for example, in U.S. Ser. No. 10/732,395 B2.

### SUMMARY

An objective according to one aspect of the present invention includes: in order from an object side, a first lens group that has positive refractive power and converts divergent light into convergent light; a second lens group that is moved along an optical axis and has negative refractive power; a third lens group that has two or more cemented surfaces; and a fourth lens group. The fourth lens group includes, in order from the object side, a meniscus lens component having a convex surface facing the object side, a lens component having a concave surface facing the object side, and a lens having a convex surface facing an image side.

### BRIEF DESCRIPTION OF THE DRAWINGS

FIG. 1 is a cross-sectional view of an objective according to Example 1 of the present invention;

FIG. 2 is a cross-sectional view of an imaging lens;

FIG. 3A is a spherical aberration diagram of an optical system including the objective and the imaging lens in a first state;

FIG. 3B is a diagram illustrating an amount of sine condition violation of the optical system including the objective and the imaging lens in the first state;

FIG. 3C is an astigmatism diagram of the optical system including the objective and the imaging lens in the first state;

FIG. 3D is a coma aberration diagram of the optical system including the objective and the imaging lens in the first state;

FIG. 4A is a spherical aberration diagram of the optical system including the objective and the imaging lens in a second state;

FIG. 4B is a diagram illustrating an amount of sine condition violation of the optical system including the objective and the imaging lens in the second state;

FIG. 4C is an astigmatism diagram of the optical system including the objective and the imaging lens in the second state;

FIG. 4D is a coma aberration diagram of the optical system including the objective and the imaging lens in the second state;

FIG. 5A is a spherical aberration diagram of the optical system including the objective and the imaging lens in a third state;

FIG. 5B is a diagram illustrating an amount of sine condition violation of the optical system including the objective and the imaging lens in the third state;

FIG. 5C is an astigmatism diagram of the optical system including the objective and the imaging lens in the third state;

FIG. 5D is a coma aberration diagram of the optical system including the objective and the imaging lens in the third state;

FIG. 6 is a cross-sectional view of an objective according to Example 2 of the present invention;

FIG. 7A is a spherical aberration diagram of an optical system including the objective and the imaging lens in a first state;

FIG. 7B is a diagram illustrating an amount of sine condition violation of the optical system including the objective and the imaging lens in the first state;

FIG. 7C is an astigmatism diagram of the optical system including the objective and the imaging lens in the first state;

FIG. 7D is a coma aberration diagram of the optical system including the objective and the imaging lens in the first state;

FIG. 8A is a spherical aberration diagram of the optical system including the objective and the imaging lens in a second state;

FIG. 8B is a diagram illustrating an amount of sine condition violation of the optical system including the objective and the imaging lens in the second state;

FIG. 8C is an astigmatism diagram of the optical system including the objective and the imaging lens in the second state;

FIG. 8D is a coma aberration diagram of the optical system including the objective and the imaging lens in the second state;

FIG. 9A is a spherical aberration diagram of the optical system including the objective and the imaging lens in a third state;

FIG. 9B is a diagram illustrating an amount of sine condition violation of the optical system including the objective and the imaging lens in the third state;

FIG. 9C is an astigmatism diagram of the optical system including the objective and the imaging lens in the third state;

FIG. 9D is a coma aberration diagram of the optical system including the objective and the imaging lens in the third state;

FIG. 10 is a cross-sectional view of an objective according to Example 3 of the present invention;

FIG. 11A is a spherical aberration diagram of an optical system including the objective and the imaging lens in a first state;

FIG. 11B is a diagram illustrating an amount of sine condition violation of the optical system including the objective and the imaging lens in the first state;

FIG. 11C is an astigmatism diagram of the optical system including the objective and the imaging lens in the first state;

FIG. 11D is a coma aberration diagram of the optical system including the objective and the imaging lens in the first state;

FIG. 12A is a spherical aberration diagram of the optical system including the objective and the imaging lens in a second state;

FIG. 12B is a diagram illustrating an amount of sine condition violation of the optical system including the objective and the imaging lens in the second state;

FIG. 12C is an astigmatism diagram of the optical system including the objective and the imaging lens in the second state;

FIG. 12D is a coma aberration diagram of the optical system including the objective and the imaging lens in the second state;

FIG. 13A is a spherical aberration diagram of the optical system including the objective and the imaging lens in a third state;

FIG. 13B is a diagram illustrating an amount of sine condition violation of the optical system including the objective and the imaging lens in the third state;

FIG. 13C is an astigmatism diagram of the optical system including the objective and the imaging lens in the third state; and

FIG. 13D is a coma aberration diagram of the optical system including the objective and the imaging lens in the third state.

### DETAILED DESCRIPTION

In the objectives in the related art, axial chromatic aberrations are not sufficiently corrected, and high off-axis aberrations such as field curvature or coma aberrations also occur. In view of such circumstances described above, an object of an aspect of the present invention is to provide an objective having a wide field of view in which a chromatic aberration and off-axis performance with respect to immersion liquids having various refractive indexes are favorably corrected.

An objective according to an embodiment of the present application will be described. The objective according to the present embodiment (hereinafter simply described as an objective) is an infinity-corrected microscope objective used in combination with an imaging lens and is an immersion microscope objective used in a state in which a space to an object that is an observation target is filled with an immersion liquid. In the present specification, a lens component refers to a single lens block in which only two surfaces that are a surface on an object side and a surface on an image side among lens surfaces through which a light ray from an object point passes are brought into contact with air regardless of whether the lens is a single lens or a cemented lens. In other words, one single lens is one lens component, and one cemented lens is also one lens component. On the other hand, a plurality of single lenses and a plurality of cemented lenses arranged with air therebetween are not referred to as one lens component herein. In addition, a meniscus lens component refers to a lens component having a meniscus lens shape, and refers to a lens component in which one of a surface closest to the object side and a surface closest to the image side of the lens component is a concave surface and the other is a convex surface.

The objective includes a first lens group having positive refractive power, a second lens group having negative refractive power, a third lens group, and a fourth lens group which are arranged in order from the object side. The first lens group converts divergent light from an object point to convergent light. The second lens group is a moving group that is moved along an optical axis. The third lens group has two or more cemented surfaces. That is, the third lens group may include two or more two-lens cemented lens components or may include one or more three-lens cemented lenses. The fourth lens group includes, in order from the object side, a meniscus lens component having a convex surface facing the object side, a lens component having a concave surface facing the object side, and a lens having a convex surface facing the image side, and the meniscus lens component having the convex surface facing the object side is located closest to the object side of the fourth lens group. Note that, in a case where a plurality of meniscus lens components having a convex surface facing the object side are provided, the meniscus lens component located closest to the image side among the meniscus lens components is the lens component located closest to the object side of the fourth lens group. Here, the lens having the convex surface facing the image side which is included in the fourth lens group may be a lens closest to the image side of the lens component having a concave surface facing the object side which is included in the fourth lens group. That is, the fourth lens group includes, in order from the object side, the meniscus lens component having the convex surface facing the object side and the lens component having the concave surface facing the object side, and has, on the image side from the concave surface facing the object side, a lens surface that is an air contact surface having a convex surface facing the image side.

In the objective configured as described above, since the second lens group that is moved in an optical axis direction is located immediately behind the first lens group in which an axial marginal light ray height reaches a maximum height, a marginal light ray height passing through the first lens group changes in a relatively high range due to the movement of the second lens group. Therefore, the amount of change in spherical aberration can be increased with respect to the movement of the second lens group, and the spherical aberration can be effectively corrected with respect to the change in thickness of the cover glass and the refractive index of the immersion liquid. In addition, similarly to the first lens group, the second lens group having a high marginal light ray height has negative refractive power so that a correction action of the axial chromatic aberration in the second lens group can be increased.

In addition, in the above-described objective, the second lens group has the negative refractive power so that a marginal light ray height in the third lens group is also increased. Therefore, the achromatic effect can be sufficiently exhibited to effectively correct the axial chromatic aberration by providing two or more cemented surfaces having an achromatic action in the third lens group having a high marginal light ray height.

Further, in the above-described objective, the fourth lens group includes an optical system having a pair of concave surfaces facing each other on an inner side and having convex surfaces at both ends (on outer sides). This optical system is generally called a Gaussian group. The fourth lens group includes the Gaussian group, thereby enabling the marginal light ray height to be lowered in the concave surfaces facing each other, and thus the Petzval sum can be effectively corrected, and as a result, a field curvature can be sufficiently reduced.

According to the objective configured as described above, the chromatic aberrations and the off-axis performance with respect to the immersion liquids having various refractive indexes can be favorably corrected in a wide field of view. A desirable configuration of the objective will be described below.

It is desirable that the number of cemented surfaces of the first lens group be smaller than the number of the cemented surfaces of the third lens group. In general, the higher the refractive index of the immersion liquid, the more the dispersion is increased. Since a light ray is the divergent light in the vicinity of a boundary surface between the immersion liquid and the objective, the higher the refractive index of the immersion liquid, the weaker the positive refractive action on the divergent light generated by the difference in refractive index, and spherical aberration is overcorrected. In addition, the higher the refractive index of the immersion liquid, and the more the dispersion increases, the axial chromatic aberration is also overcorrected. Considering that an effect caused by the change in the refractive index of the immersion liquid is corrected by the movement of the second lens group, it is desirable to increase the marginal light ray height in the first lens group by the movement of the second lens group so that the spherical aberration is increased, and at the same time, the axial chromatic aberration that occurs in the first lens group is also increased. By reducing the number of the cemented surfaces of the first lens group, particularly, by reducing the number of the cemented surfaces of the first lens group to be smaller than the number of the cemented surfaces of the third lens group, an axial chromatic aberration correcting action in the first lens group can be made sufficiently smaller than an axial chromatic aberration correcting action in the third lens group. Consequently, since the above-described effect, that is, the effect of curbing the overcorrection by the movement of the second lens group, can be obtained, the spherical aberration and the chromatic aberration can be favorably corrected even with respect to an immersion liquid having a high refractive index and a high dispersion.

It is desirable that the first lens group include three or more lens components, each of which has positive refractive power. The first lens group includes three or more lens components, thereby enabling light diverging from an object point to gradually converge, so that the spherical aberration and the coma aberration can be mainly prevented from occurring too much. Further, it is desirable that the three or more lens components included in the first lens group have common characteristics that none of these lens components is a cemented lens in which a negative lens is located closer to the object side with respect to a positive lens. This configuration enables the spherical aberration to be favorably corrected between different wavelengths (that is, in a wide wavelength range). More specifically, when the first lens group includes the cemented lens in which the negative lens is located on the object side, divergent light is incident on a cemented surface that has an achromatic action and is positioned on the image side of the negative lens, and an incident angle of a marginal light ray with respect to the cemented surface increases. Since a refraction angle is proportional to the sine of an incident angle, the larger the incident angle, the larger the refraction angle. As a result, a difference in the refraction angle which is made between the wavelengths also increases. That is, the presence of the cemented lens in which the negative lens is located on the object side in the first lens group causes a large refraction angle difference between wavelengths. When the marginal light ray height in the first lens group is changed by the movement of the second lens group in a state in which such a cemented lens is provided in the first lens group, a large difference in the refraction angle between different wavelengths on the cemented surface significantly varies, so that it becomes difficult to reduce the change in the spherical aberration between different wavelengths (that is, in a wide wavelength range). On the contrary, in the above-described objective, since the first lens group does not include the cemented lens in which the negative lens is located closer to the object side with respect to the positive lens, such a difficulty does not occur, and it is possible to favorably correct the spherical aberration between different wavelengths (that is, in a wide wavelength range) in all of the states corresponding to the individual immersion liquids.

It is desirable that the first lens group include a first lens component located closest to the object side, and three or more single lenses, each of which has positive refractive power. The first lens group includes three or more positive lenses in addition to the first lens component, thereby enabling the light diverging from the object point to gradually converge, so that the spherical aberration and the coma aberration can be mainly prevented from occurring too much. In addition, each of the three or more positive lenses is not the cemented lens but the single lens, thereby enabling too large an increase in the axial chromatic aberration correcting action to be avoided in the first lens group. As a result, for the same reason as described above in a relationship between the number of cemented surfaces of the first lens group and the number of cemented surfaces of the third lens group, the spherical aberration and the chromatic aberration can be favorably corrected even with respect to an immersion liquid having a large refractive index and a high dispersion.

It is desirable that the first lens group include the first lens component in which a positive lens having a convex surface facing the image side and a meniscus lens having a concave surface facing the object side are cemented, the first lens component being provided closest to the object side. The first lens component positioned closest to the object side is the cemented lens including the positive lens having the convex surface facing the image side and the meniscus lens having the concave surface facing the object side, thereby enabling the field curvature to be favorably corrected. More specifically, by imparting a refraction action due to the concave surface of the meniscus lens at a cemented surface of the first lens component on which light emitted from the object point is incident before the marginal light ray height increases, it is possible to effectively correct the Petzval sum. In addition, since a lens cemented to the concave surface of the meniscus lens on the object side is a positive lens, a first surface (lens surface closest to the object side) of the objective does not become a strong concave surface. Hence, it is possible to avoid generation of air bubbles on an optical path when the objective is immersed in an immersion liquid, and as a result, it is possible to avoid generation of an aberration.

It is desirable that the second lens group be a cemented lens component including a negative lens and a positive lens from the object side. The second lens group that has negative refractive power and an achromatic action is configured as a cemented lens component, thereby enabling more effective axial chromatic aberration correction to be performed. In addition, since convergent light is incident on the second lens group, the cemented lens component that is the second lens group is arranged in the order of the negative lens and the positive lens from the object side, so that a refraction angle of a marginal light ray at the cemented surface does not become too large. Consequently, it is possible to reduce a change in spherical aberration between different wavelengths (that is, in a wide wavelength range) with respect to the change in the marginal light ray height in the second lens group which is caused by the movement of the second lens group, and it is possible to favorably correct the spherical aberration between different wavelengths (that is, in a wide wavelength range) in all the states corresponding to the individual immersion liquids.

It is desirable that the fourth lens group include three or more lens components. The fourth lens group includes three or more lens components, thereby enabling a lateral chromatic aberration and differences in astigmatism and coma aberration between wavelengths to be corrected simultaneously. It is preferable that, in the fourth lens group located closest to the image side, a lens pair having a different dispersion characteristic be arranged in order to correct a lateral chromatic aberration. However, when the lens pair having different dispersion characteristics is cemented, large differences are generated in the coma aberration and the astigmatism occurring at a cemented surface due to the wavelengths. On the contrary, the fourth lens group is configured to include three or more lens components, thereby enabling one or more pairs of air interfaces (that is, one or more gaps generated between the lens components) to be provided in addition to the above-described concave surfaces facing each other which have a Petzval sum correcting action. Therefore, it is possible to favorably correct astigmatism and a coma aberration by making differences in the refraction angle and the light ray height of an off-axis light ray at these surfaces (the concave surfaces facing each other and the one or more pairs of air interfaces). As a result, the lateral chromatic aberration, the astigmatism, and the coma aberration can be corrected more favorably in a wide wavelength range.

It is desirable that the fourth lens group include a lens component having positive refractive power between the lens component having the concave surface facing the object side which is included in the fourth lens group and the lens having the convex surface facing the image side which is included in the fourth lens group. The lens component further having the positive refractive power between the lens component having the concave surface facing the object side and the lens having a convex surface on the image side are included, thereby enabling the lateral chromatic aberration, the astigmatism, and the coma aberration to be further favorably corrected simultaneously. The lens component is additionally arranged closer to the object side with respect to the lens having the convex surface facing the image side, thereby enabling another pair of air interfaces to be provided. Consequently, it is possible to favorably correct the astigmatism and the coma aberration by making differences in the refraction angle and the light ray height of an off-axis light ray at these surfaces (the concave surfaces facing each other and the two or more pairs of air interfaces). Note that, in a case where the fourth lens group includes a plurality of lenses having a convex surface facing the image side, it is desirable that a lens component having positive refractive power be included between a lens having a convex surface facing the image side which is located closest to the image side, among the plurality of lenses, and a lens component having a concave surface facing the object side. In addition, in the fourth lens group, in a case where a plurality of lens components having a concave surface facing the object side are provided between a meniscus lens component having a convex surface facing the object side and a lens having a convex surface facing the image side, it is desirable to include a lens component having positive refractive power between a lens component having a concave surface facing the object side which is located closest to the object side, among the plurality of lens components, and a lens having a convex surface facing the image side.

It is desirable that the objective be configured to satisfy at least one of Conditional Expressions (1) and (2) below.

0≤D_{2G}/TL≤0.16 (1)

0.2≤Φ_{L}/TL≤0.6 (2)

Here, D_{2G} denotes a distance on the optical axis from a surface of the second lens group which is closest to the object side to a surface of the second lens group which is closest to the image side. TL denotes a distance on the optical axis from a surface of the objective which is closest to the object side to a surface of the objective which is closest to the image side. Φ_{L} denotes an outer diameter of a lens of the objective which is closest to the image side. Note that an outer diameter of a lens is usually a value that is, by about 0.5 mm to 1 mm, larger than an effective diameter (diameter) of a surface of the lens on the image side.

Conditional Expression (1) is a conditional expression for favorably correcting the spherical aberration with respect to refractive indexes of the immersion liquids in a wide range. D_{2G}/TL is not higher than an upper limit value, thereby enabling a space occupied by the second lens group in the objective to be prevented from becoming too large. Consequently, since a sufficient movement amount of the second lens group can be ensured in the objective, the spherical aberration can be corrected with respect to the refractive indexes of the immersion liquids in a wide range. D_{2G}/TL is not lower than a lower limit value.

Conditional Expression (2) is a conditional expression for reducing the vignetting over a wide field of view and correcting the field curvature favorably. In the objective having a long focal length and a low magnification for realizing a wide field of view, a diameter of an optical surface of the lens closest to the image side can be prevented from becoming too small by preventing Φ_{L}/TL from becoming smaller than the lower limit value. Consequently, a distance between a final surface and an exit pupil position can be maintained long while an exit area is maintained large by reducing the vignetting of an off-axis light ray. Therefore, an effect of correcting the Petzval sum of the Gaussian group included in the fourth lens group can be more significantly exhibited, and the field curvature can be effectively corrected. In addition, Φ_{L}/TL is not larger than the upper limit value, thereby enabling stiffness of the lens to be secured and enabling an increase in size of the objective to be avoided.

Note that the objective may be configured to satisfy Conditional Expression (1-1) or Conditional Expression (1-2) below, in addition to Conditional Expression (1). In addition, the objective may be configured to satisfy Conditional Expression (2-1) or Conditional Expression (2-2) below, in addition to Conditional Expression (2).

0.02≤D_{2G}/TL≤0.14 (1-1)

0.03≤D_{2G}/TL≤0.12 (1-1)

0.24≤Φ_{L}/TL≤0.55 (2-1)

0.28≤Φ_{L}/TL≤0.5 (2-2)

Hereinafter, examples of the above-described objective will be described in detail.

### Example 1

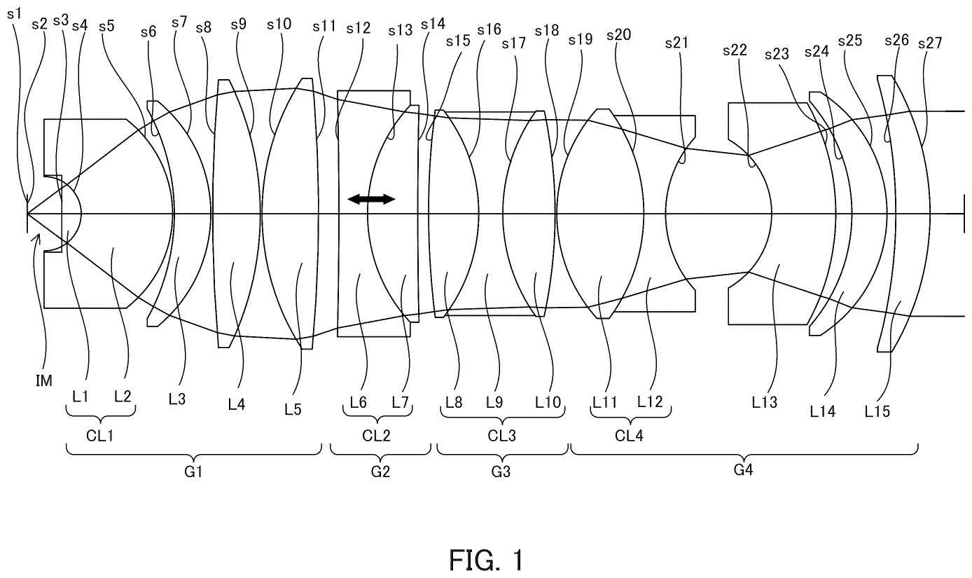

FIG. 1 is a cross-sectional view of an objective 1 according to the present example. The objective 1 is a liquid immersion objective for microscope. The objective 1 includes, in order from the object side, a first lens group G1 that has positive refractive power, a second lens group G2 that is moved along an optical axis and has negative refractive power, a third lens group G3, and a fourth lens group G4.

The first lens group G1 includes, in order from the object side, a cemented lens CL1, a lens L3 that is a meniscus lens having a concave surface facing the object side, a lens L4 that is a biconvex lens, and a lens L5 that is a biconvex lens. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power. The first lens group G1 has one cemented surface. Note that the cemented lens CL1 is not a cemented lens in which a negative lens is located closer to the object side with respect to the positive lens. The lens L3, the lens L4, and the lens L5 are all positive lenses, and the first lens group G1 includes three or more single lenses.

The second lens group G2 includes a cemented lens CL2 that is moved along the optical axis. The cemented lens CL2 is a two-lens cemented lens in which a lens L6 that is a biconcave lens and a lens L7 that is a meniscus lens having a concave surface facing the image side are cemented. The lens L6 is a negative lens, and the lens L7 is a positive lens.

The third lens group G3 includes a cemented lens CL3. The cemented lens CL3 is a three-lens cemented lens in which a lens L8 that is a biconvex lens, a lens L9 that is a biconcave lens, and a lens L10 that is a biconvex lens are cemented, and the cemented lens CL3 has two cemented surfaces. That is, in the objective 1, the number of (one) cemented surfaces of the first lens group G1 is smaller than the number of (two) cemented surfaces of the third lens group G3.

The fourth lens group G4 includes, in order from the object side, a cemented lens CL4, a lens L13 that is a meniscus lens having a concave surface facing the object side, a lens L14 that is a meniscus lens having a concave surface facing the object side, and a lens L15 that is a meniscus lens having a concave surface facing the object side. The cemented lens CL4 is a two-lens cemented lens in which a lens L11 that is a biconvex lens and a lens L12 that is a biconcave lens are cemented. Note that the lens L14 has positive refractive power. Hence, the fourth lens group G4 is configured to have, as a lens closest to the object side, the cemented lens CL4 that is a meniscus lens component having a convex surface facing the object side, and to include the lens L14 that is a lens component having positive refractive power between the lens L13 that is a lens component having a concave surface facing the object side and the lens L15 that is a lens having a convex surface facing the image side.

Various items of data of the objective 1 are as follows. Note that the NA is a numerical aperture of the objective 1 on the object side, and f, f_{G1}, f_{G2}, f_{G3}, and f_{G4} are a focal length of the objective 1, a focal length of the first lens group G1, a focal length of the second lens group G2, a focal length of the third lens group G3, and a focal length of the fourth lens group G4, respectively. Note that a reference wavelength is the d-line.
NA=0.8, f=11.255 mm, f_{G1}=8.798 mm, f_{G2}=−59.549 mm, f_{G3}=−110.028 mm, f_{G4}=−769.764 mm, D_{2G}=6.898 mm, TL=75.980 mm, Φ_{L}=²⁴0.00 mm

Lens data of the objective 1 is as follows. Note that the INF in the lens data indicates infinity (∞).

Objective Lens 1

| s | r | d | nd | vd |
|---|---|---|---|---|
| 1 | INF | 0 | nim | Vim |
| 2 | INF | D2 | nim | Vim |
| 3 | INF | 1.7 | 1.45858 | 67.84 |
| 4 | −3.254 | 8.000 | 1.88300 | 40.76 |
| 5 | −10.4500 | 0.150 | | |
| 6 | −19.0491 | 3.197 | 1.56907 | 71.30 |
| 7 | −12.7892 | 0.150 | | |
| 8 | 132.2087 | 4.178 | 1.56907 | 71.30 |
| 9 | −26.5420 | 0.150 | | |
| 10 | 21.8276 | 4.9542 | 1.56907 | 71.30 |
| 11 | −124.5595 | D11 | | |
| 12 | −455.2269 | 2.500 | 1.63775 | 42.41 |
| 13 | 13.9586 | 4.398 | 1.43875 | 94.66 |
| 14 | 416.9798 | D14 | | |
| 15 | 71.5632 | 4.386 | 1.43875 | 94.66 |
| 16 | −14.9035 | 2.100 | 1.63775 | 42.41 |
| 17 | 15.3955 | 4.580 | 1.43875 | 94.66 |
| 18 | −43.2531 | 0.150 | | |
| 19 | 13.7057 | 7.618 | 1.56907 | 71.30 |
| 20 | −15.3660 | 1.900 | 1.51633 | 64.14 |
| 21 | 9.9755 | 9.287 | | |
| 22 | −7.4749 | 5.612 | 1.83481 | 42.74 |
| 23 | −20.0064 | 1.406 | | |
| 24 | −14.9926 | 3.076 | 1.70154 | 41.24 |
| 25 | −12.6493 | 0.766 | | |
| 26 | −43.9161 | 3.000 | 1.65412 | 39.68 |
| 27 | −23.5693 | 60.000 | | |

Here, s denotes a surface number, r denotes a curvature radius (mm), d denotes a surface spacing (mm), nd denotes a refractive index, and vd denotes an Abbe number. Note that the reference wavelength is the d-line (587.56 nm). These symbols are similarly used in the following examples. Both surfaces indicated by surface numbers s1 and s2 are object surfaces. Surfaces indicated by surface numbers s3 and s27 are a lens surface of the objective 1 which is closest to the object side and a lens surface of the objective 1 which is closest to the image side, respectively. A space between an object surface and the lens surface of the objective 1 which is closest to the object side is filled with an immersion liquid IM. The refractive index and the Abbe number of the immersion liquid IM are denoted by nᵢₘ and vᵢₘ, respectively. In addition, for example, a surface spacing d1 indicates a distance on the optical axis from the surface indicated by the surface number s1 to the surface indicated by the surface number s2. Note that a surface spacing d27 indicates a distance on the optical axis from the surface indicated by the surface number s27 to an imaging lens and is 60 mm.

In the observation performed by using the objective 1, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. The refractive index nᵢₘ and the Abbe number vᵢₘ of the immersion liquid, and D2, D11, and D14 that are values (unit: mm) of spacings d2, d11, and d14 in the lens data in each state are as follows.

| | First state | Second state | Third state |
|---|---|---|---|
| nᵢₘ | 1.33304 | 1.38100 | 1.40410 |
| vᵢₘ | 55.8 | 52.2 | 51.9 |
| D2 | 3.022 | 3.087 | 3.120 |
| D11 | 1.775 | 2.208 | 2.400 |
| D14 | 0.948 | 0.514 | 0.322 |

The objective 1 satisfies Conditional Expressions (1) and (2) as will be described below.

D_{2G}/TL=0.09 (1)

Φ_{L}/TL=0.32 (2)

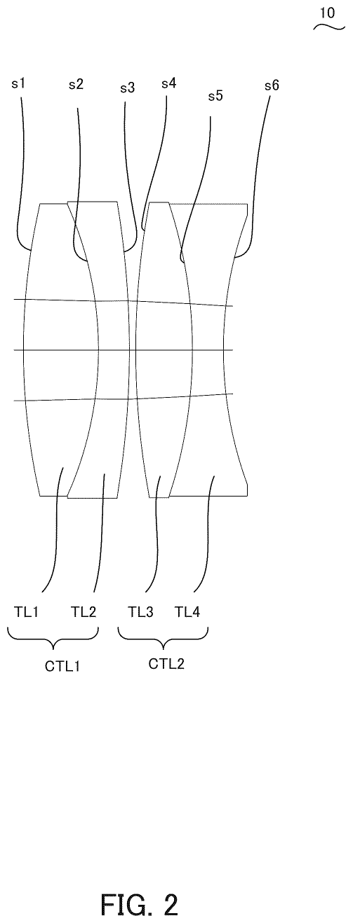

FIG. 2 is a cross-sectional view of an imaging lens 10 used in combination with the objective 1. The imaging lens 10 is a microscope imaging lens that forms an enlarged image of an object in combination with an infinity-corrected objective. The imaging lens 10 includes a cemented lens CTL1 and a cemented lens CTL2 which are arranged in order from the object side. The cemented lens CTL1 is a two-lens cemented lens including a lens TL1 that is a biconvex lens and a lens TL2 that is a meniscus lens having a concave surface facing the object side. The cemented lens CTL2 is a two-lens cemented lens including a lens TL3 that is a biconvex lens and a lens TL4 that is a biconcave lens. Note that a focal length ft of the imaging lens 10 is 180 mm.

Lens data of the imaging lens 10 is as follows.

Imaging Lens 10

| s | r | d | nd | vd |
|---|---|---|---|---|
| 1 | 68.7541 | 7.7321 | 1.48749 | 70.21 |
| 2 | −37.5679 | 3.4742 | 1.80610 | 40.95 |
| 3 | −102.8477 | 0.6973 | | |
| 4 | 84.3099 | 6.024 | 1.83400 | 37.17 |
| 5 | −50.7100 | 3.030 | 1.64450 | 40.82 |
| 6 | 40.6619 | 9.038 | | |

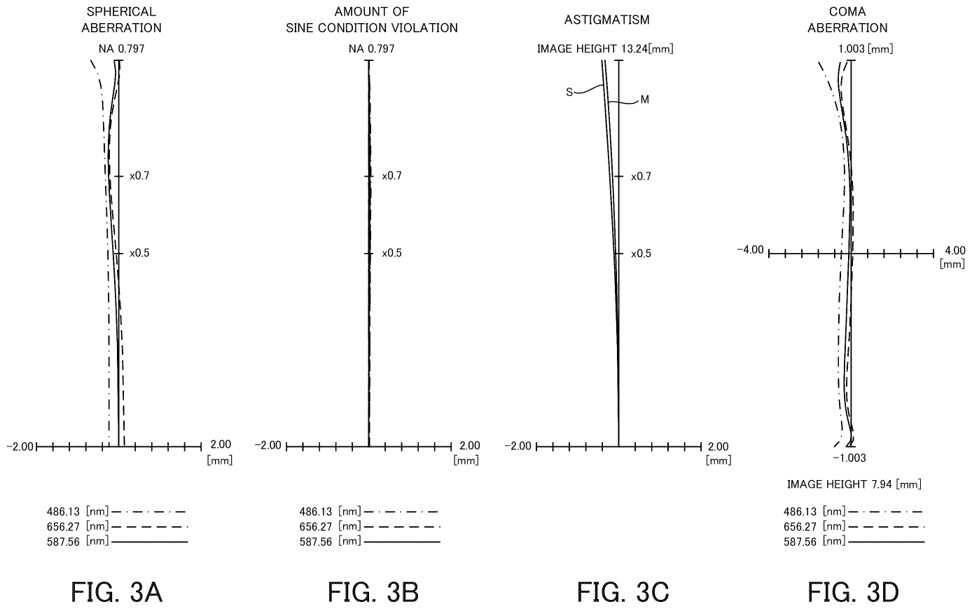

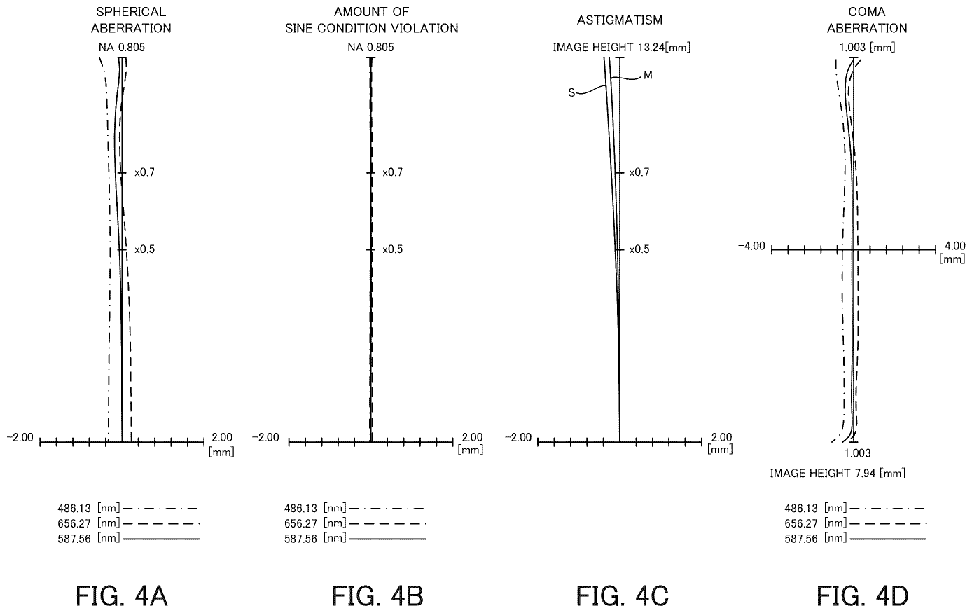

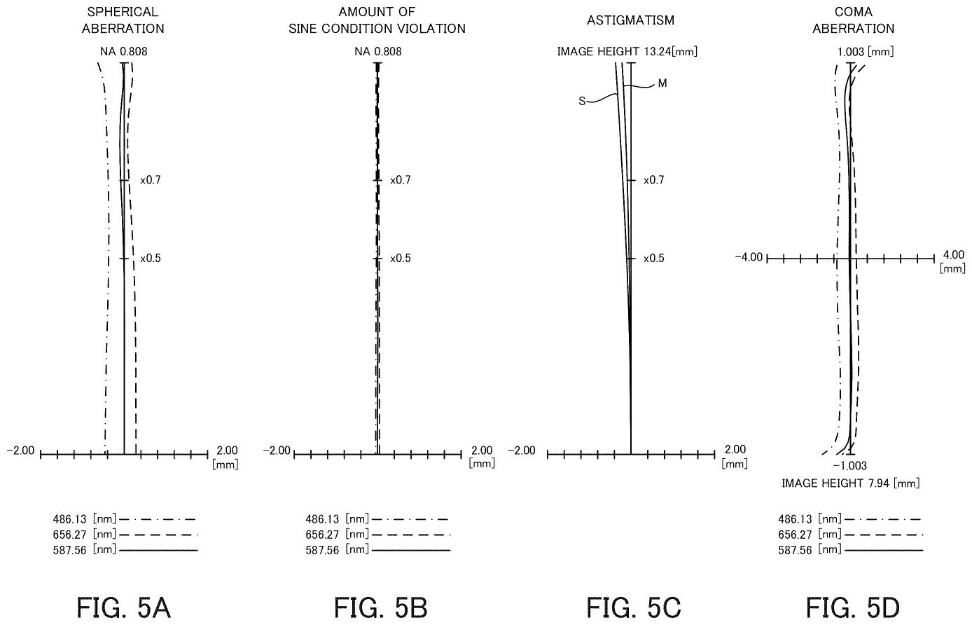

FIGS. 3A to 5D are aberration diagrams of an optical system including the objective 1 and the imaging lens 10 and illustrate aberrations at an image plane formed by the objective 1 and the imaging lens 10 in the first state, the second state, and the third state, respectively. FIGS. 3A, 4A, and 5A are spherical aberration diagrams. FIGS. 3B, 4B, and 5B are diagrams illustrating the amounts of sine condition violation. FIGS. 3C, 4C, and 5C are astigmatism diagrams. FIGS. 3D, 4D, and 5D are coma aberration diagrams at an image height ratio of 0.6 (an image height of 7.94 mm). Note that, in the figures, “M” denotes a meridional component, and “S” denotes a sagittal component. As illustrated in FIGS. 3A to 5D, in the present example, the aberrations are favorably corrected regardless of the immersion liquids in the case of using the immersion liquids depending on a refractive index of an object.

### Example 2

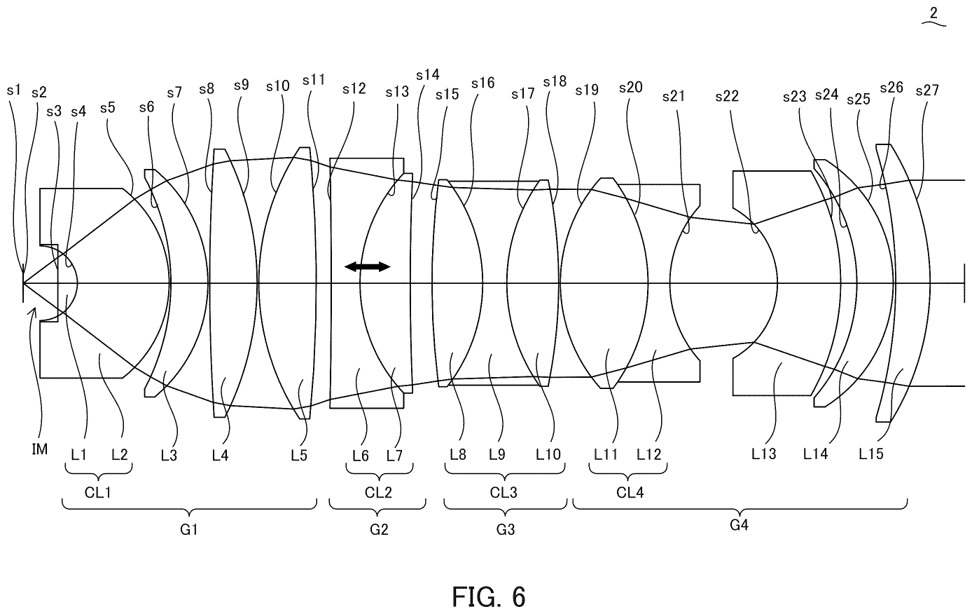

FIG. 6 is a cross-sectional view of an objective 2 according to the present example. The objective 2 is a liquid immersion objective for microscope. The objective 2 includes, in order from the object side, a first lens group G1 that has positive refractive power, a second lens group G2 that is moved along an optical axis and has negative refractive power, a third lens group G3, and a fourth lens group G4.

The first lens group G1 includes, in order from the object side, a cemented lens CL1, a lens L3 that is a meniscus lens having a concave surface facing the object side, a lens L4 that is a biconvex lens, and a lens L5 that is a biconvex lens. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power. The first lens group G1 has one cemented surface. Note that the cemented lens CL1 is not a cemented lens in which a negative lens is located closer to the object side with respect to the positive lens. The lens L3, the lens L4, and the lens L5 are all positive lenses, and the first lens group G1 includes three or more single lenses.

The second lens group G2 includes a cemented lens CL2 that is moved along the optical axis. The cemented lens CL2 is a two-lens cemented lens in which a lens L6 that is a biconcave lens and a lens L7 that is a meniscus lens having a concave surface facing the image side are cemented. The lens L6 is a negative lens, and the lens L7 is a positive lens.

The third lens group G3 includes a cemented lens CL3. The cemented lens CL3 is a three-lens cemented lens in which a lens L8 that is a biconvex lens, a lens L9 that is a biconcave lens, and a lens L10 that is a biconvex lens are cemented, and the cemented lens CL3 has two cemented surfaces. That is, in the objective 2, the number of (one) cemented surfaces of the first lens group G1 is smaller than the number of (two) cemented surfaces of the third lens group G3.

The fourth lens group G4 includes, in order from the object side, a cemented lens CL4, a lens L13 that is a meniscus lens having a concave surface facing the object side, a lens L14 that is a meniscus lens having a concave surface facing the object side, and a lens L15 that is a meniscus lens having a concave surface facing the object side. The cemented lens CL4 is a two-lens cemented lens in which a lens L11 that is a biconvex lens and a lens L12 that is a biconcave lens are cemented. Note that the lens L14 has positive refractive power. Hence, the fourth lens group G4 is configured to have, as a lens closest to the object side, the cemented lens CL4 that is a meniscus lens component having a convex surface facing the object side, and to include the lens L14 that is a lens component having positive refractive power between the lens L13 that is a lens component having a concave surface facing the object side and the lens L15 that is a lens having a convex surface facing the image side.

Various items of data of the objective 2 are as follows. Note that the NA is a numerical aperture of the objective 2 on the object side, and f, f_{G1}, f_{G2}, f_{G3}, and f_{G4} are a focal length of the objective 2, a focal length of the first lens group G1, a focal length of the second lens group G2, a focal length of the third lens group G3, and a focal length of the fourth lens group G4, respectively. Note that a reference wavelength is the d-line.
NA=0.8, f=11.255 mm, f_{G1}=8.725 mm, f_{G2}=−56.771 mm, f_{G3}=−105.658 mm, f_{G4}=−1126.65 mm, D_{2G}=6.881 mm, TL=75.981 mm, Φ_{L}=24.00 mm

Lens data of the objective 2 is as follows.

Objective Lens 2

| s | r | d | nd | vd |
|---|---|---|---|---|
| 1 | INF | 0 | nim | Vim |
| 2 | INF | D2 | nim | Vim |
| 3 | INF | 1.7 | 1.45858 | 67.84 |
| 4 | −3.2538 | 8.000 | 1.88300 | 40.76 |
| 5 | −10.4380 | 0.150 | | |
| 6 | −19.7302 | 3.229 | 1.56907 | 71.30 |
| 7 | −12.9227 | 0.150 | | |
| 8 | 176.1926 | 4.129 | 1.56907 | 71.30 |
| 9 | −25.7250 | 0.150 | | |
| 10 | 21.4187 | 5.007 | 1.56907 | 71.30 |
| 11 | −123.8120 | D11 | | |
| 12 | −497.4926 | 2.500 | 1.63775 | 42.41 |
| 13 | 13.9700 | 4.381 | 1.43875 | 94.66 |
| 14 | 223.4818 | D14 | | |
| 15 | 70.3632 | 4.410 | 1.43875 | 94.66 |
| 16 | −14.6781 | 2.100 | 1.63775 | 42.41 |
| 17 | 15.4810 | 4.514 | 1.43875 | 94.66 |
| 18 | −44.7102 | 0.150 | | |
| 19 | 13.7361 | 7.638 | 1.56907 | 71.30 |
| 20 | −15.3156 | 1.900 | 1.51633 | 64.14 |
| 21 | 10.0144 | 9.376 | | |
| 22 | −7.4907 | 5.506 | 1.83481 | 42.74 |
| 23 | −19.7662 | 1.410 | | |
| 24 | −15.2663 | 3.166 | 1.70154 | 41.24 |
| 25 | −12.7626 | 0.213 | | |
| 26 | −41.3331 | 3.000 | 1.65412 | 39.68 |
| 27 | −22.9748 | 60.000 | | |

In the observation performed by using the objective 2, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. The refractive index nᵢₘ and the Abbe number vᵢₘ of the immersion liquid, and D2, D11, and D14 that are values (unit: mm) of spacings d2, d11, and d14 in the lens data in each state are as follows.

| | First state | Second state | Third state |
|---|---|---|---|
| nᵢₘ | 1.33304 | 1.40410 | 1.51800 |
| vᵢₘ | 55.8 | 51.9 | 40.0 |
| D2 | 3.022 | 3.118 | 3.283 |
| D11 | 1.304 | 1.906 | 2.700 |
| D14 | 1.899 | 1.297 | 0.503 |

The objective 2 satisfies Conditional Expressions (1) and (2) as will be described below.

D_{2G}/TL=0.09 (1)

Φ_{L}/TL=0.32 (2)

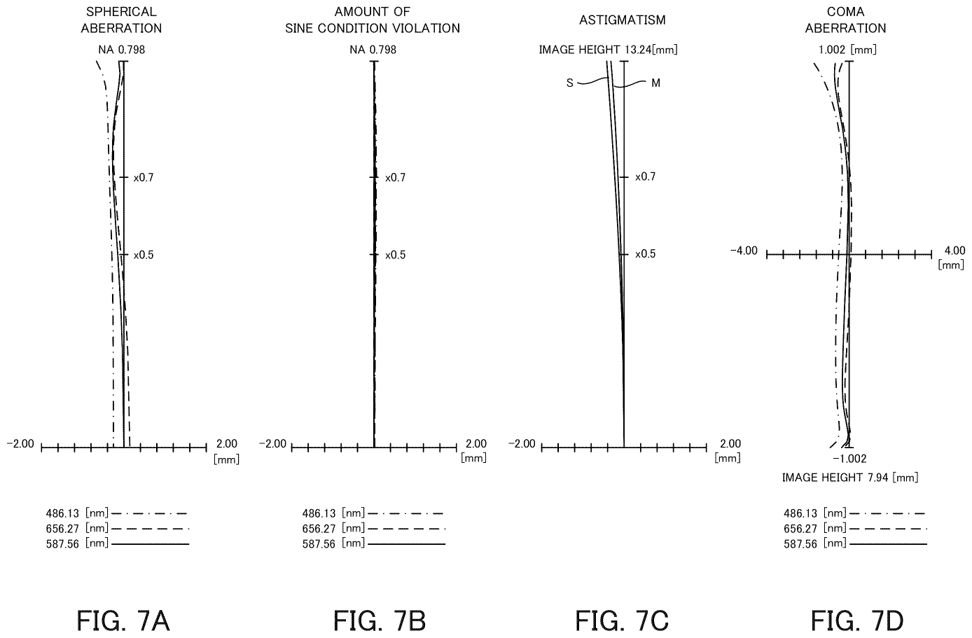

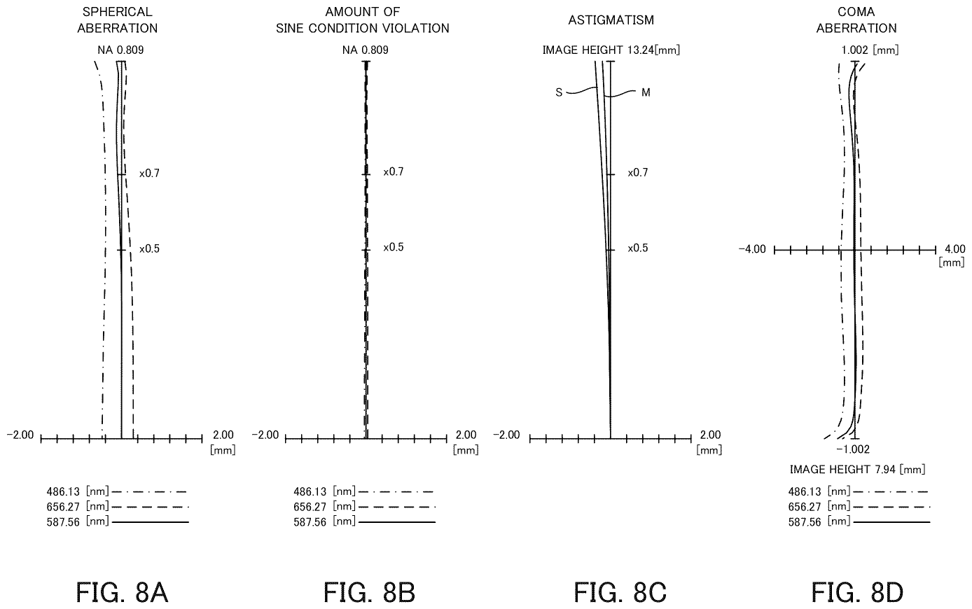

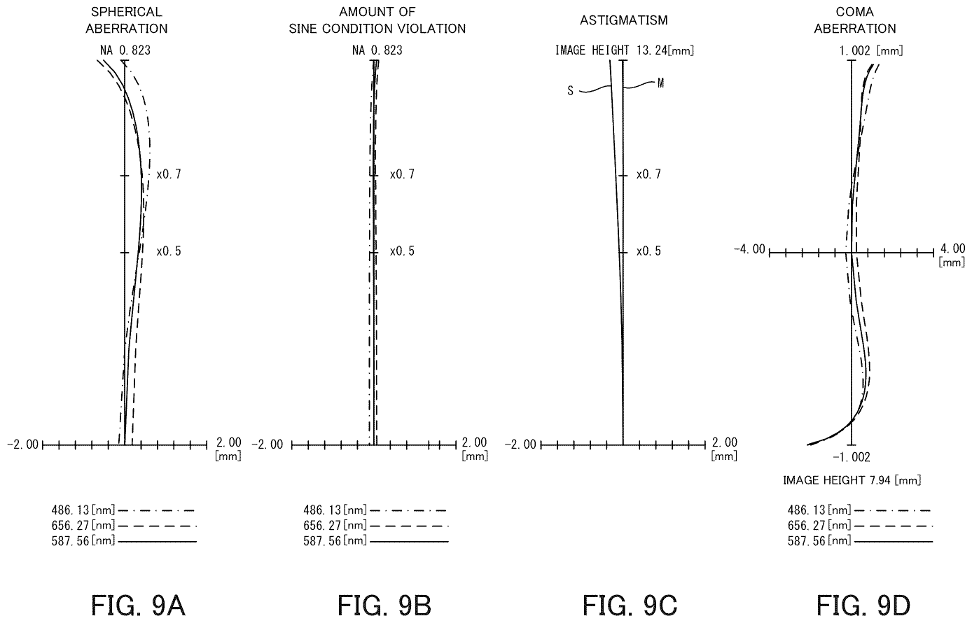

FIGS. 7A to 9D are aberration diagrams of an optical system including the objective 2 and the imaging lens 10 and illustrate aberrations at an image plane formed by the objective 2 and the imaging lens 10 in the first state, the second state, and the third state, respectively. FIGS. 7A, 8A, and 9A are spherical aberration diagrams. FIGS. 7B, 8B, and 9B are diagrams illustrating the amounts of sine condition violation. FIGS. 7C, 8C, and 9C are astigmatism diagrams. FIGS. 7D, 8D, and 9D are coma aberration diagrams at the image height ratio of 0.6 (the image height of 7.94 mm). As illustrated in FIGS. 7A to 9D, in the present example, the aberrations are favorably corrected regardless of the immersion liquids in the case of using the immersion liquids depending on a refractive index of an object.

### Example 3

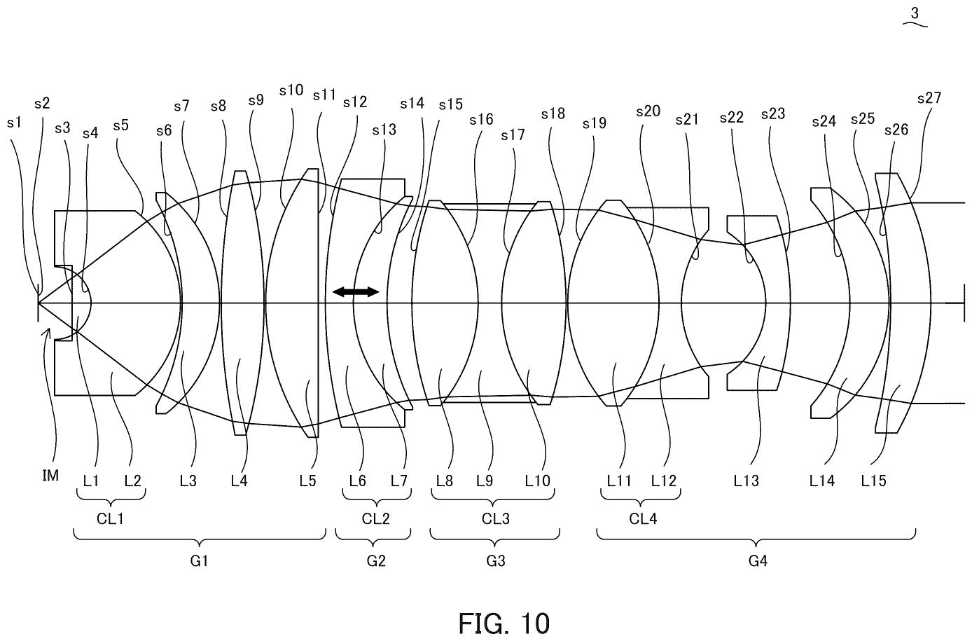

FIG. 10 is a cross-sectional view of an objective 3 according to the present example. The objective 3 is a liquid immersion objective for microscope. The objective 3 includes, in order from the object side, a first lens group G1 that has positive refractive power, a second lens group G2 that is moved along an optical axis and has negative refractive power, a third lens group G3, and a fourth lens group G4.

The first lens group G1 includes, in order from the object side, a cemented lens CL1, a lens L3 that is a meniscus lens having a concave surface facing the object side, a lens L4 that is a biconvex lens, and a lens L5 that is a plano-convex lens having a flat surface facing the image side. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power. The first lens group G1 has one cemented surface. Note that the cemented lens CL1 is not a cemented lens in which a negative lens is located closer to the object side with respect to the positive lens. The lens L3, the lens L4, and the lens L5 are all positive lenses, and the first lens group G1 includes three or more single lenses.

The second lens group G2 includes a cemented lens CL2 that is moved along the optical axis. The cemented lens CL2 is a two-lens cemented lens in which a lens L6 that is a meniscus lens having a concave surface facing the image side and a lens L7 that is a meniscus lens having a concave surface facing the image side are cemented. The lens L6 is a negative lens, and the lens L7 is a positive lens.

The third lens group G3 includes a cemented lens CL3. The cemented lens CL3 is a three-lens cemented lens in which a lens L8 that is a biconvex lens, a lens L9 that is a biconcave lens, and a lens L10 that is a biconvex lens are cemented, and the cemented lens CL3 has two cemented surfaces. That is, in the objective 3, the number of (one) cemented surfaces of the first lens group G1 is smaller than the number of (two) cemented surfaces of the third lens group G3.

The fourth lens group G4 includes, in order from the object side, a cemented lens CL4, a lens L13 that is a meniscus lens having a concave surface facing the object side, a lens L14 that is a meniscus lens having a concave surface facing the object side, and a lens L15 that is a meniscus lens having a concave surface facing the object side. The cemented lens CL4 is a two-lens cemented lens in which a lens L11 that is a biconvex lens and a lens L12 that is a biconcave lens are cemented. Note that the lens L14 has positive refractive power. Hence, the fourth lens group G4 is configured to have, as a lens closest to the object side, the cemented lens CL4 that is a meniscus lens component having a convex surface facing the object side, and to include the lens L14 that is a lens component having positive refractive power between the lens L13 that is a lens component having a concave surface facing the object side and the lens L15 that is a lens having a convex surface facing the image side.

Various items of data of the objective 3 are as follows. Note that the NA is a numerical aperture of the objective 3 on the object side, and f, f_{G1}, f_{G2}, f_{G3}, and f_{G4} are a focal length of the objective 3, a focal length of the first lens group G1, a focal length of the second lens group G2, a focal length of the third lens group G3, and a focal length of the fourth lens group G4, respectively. Note that a reference wavelength is the d-line.

NA=0.8, f=11.252 mm, f_{G1}=9.284 mm, f_{G2}=−44.054 mm, f_{G3}=263.334 mm, f_{G4}=−559.017 mm, D_{2G}=5.514 mm, TL=76.781 mm, Φ_{L}=23.00 mm

Lens data of the objective 3 is as follows.

Objective Lens 3

| s | r | d | nd | vd |
|---|---|---|---|---|
| 1 | INF | 0 | nim | Vim |
| 2 | INF | D2 | nim | Vim |
| 3 | INF | 1.7 | 1.45858 | 67.84 |
| 4 | −3.2577 | 8.000 | 1.88300 | 40.76 |
| 5 | −10.4302 | 0.150 | | |
| 6 | −19.4023 | 3.343 | 1.56907 | 71.30 |
| 7 | −12.5977 | 0.150 | | |
| 8 | 56.9714 | 3.829 | 1.56907 | 71.30 |
| 9 | −43.5557 | 0.150 | | |
| 10 | 20.9922 | 4.6928 | 1.56907 | 71.30 |
| 11 | INF | D11 | | |
| 12 | 43.6310 | 2.500 | 1.63775 | 42.41 |
| 13 | 12.1938 | 3.014 | 1.43875 | 94.66 |
| 14 | 20.1393 | D14 | | |
| 15 | 28.1316 | 5.927 | 1.43875 | 94.66 |
| 16 | −14.2012 | 2.100 | 1.63775 | 42.41 |
| 17 | 14.3611 | 5.758 | 1.43875 | 94.66 |
| 18 | −30.0287 | 0.150 | | |
| 19 | 14.0184 | 8.161 | 1.56907 | 71.30 |
| 20 | −14.1353 | 2.000 | 1.51633 | 64.14 |
| 21 | 10.0867 | 7.551 | | |
| 22 | −7.5998 | 2.200 | 1.61340 | 44.27 |
| 23 | −25.6000 | 5.317 | | |
| 24 | −13.8847 | 3.500 | 1.70154 | 41.24 |
| 25 | −12.7161 | 0.150 | | |
| 26 | −46.3160 | 3.586 | 1.65412 | 39.68 |
| 27 | −23.8710 | 60.000 | | |

In the observation performed by using the objective 3, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. The refractive index nᵢₘ and the Abbe number vᵢₘ of the immersion liquid, and D2, D11, and D14 that are values (unit: mm) of spacings d2, d11, and d14 in the lens data in each state are as follows.

| | First state | Second state | Third state |
|---|---|---|---|
| nim | 1.33304 | 1.40410 | 1.51800 |
| Vim | 55.8 | 51.9 | 48.0 |
| D2 | 3.016 | 3.145 | 3.358 |
| D11 | 0.637 | 1.106 | 1.717 |
| D14 | 2.216 | 1.747 | 1.136 |

The objective 3 satisfies Conditional Expressions (1) and (2) as will be described below.

D_{2G}/TL=0.07 (1)

Φ_{L}/TL=0.30 (2)

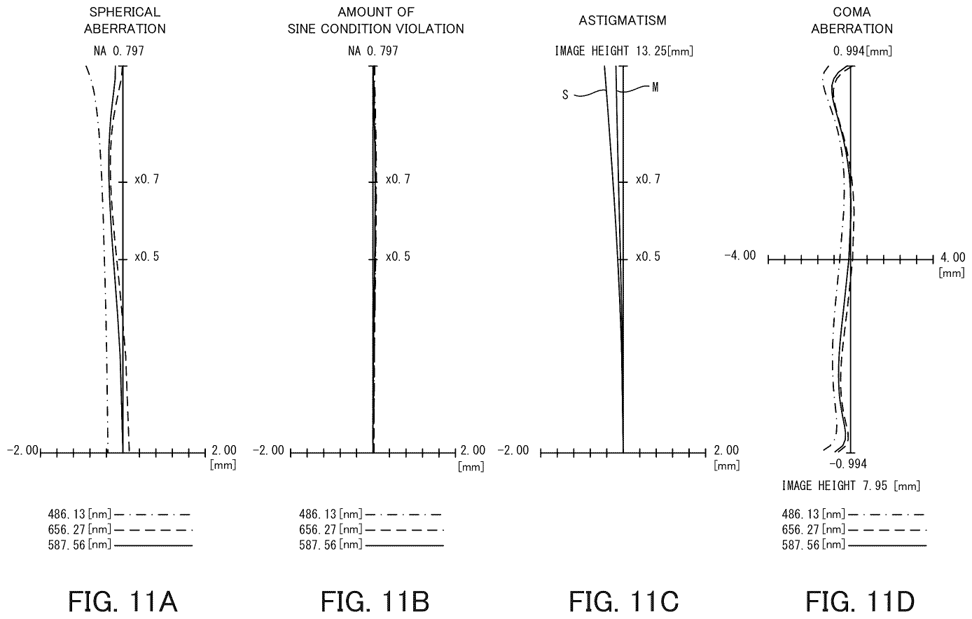

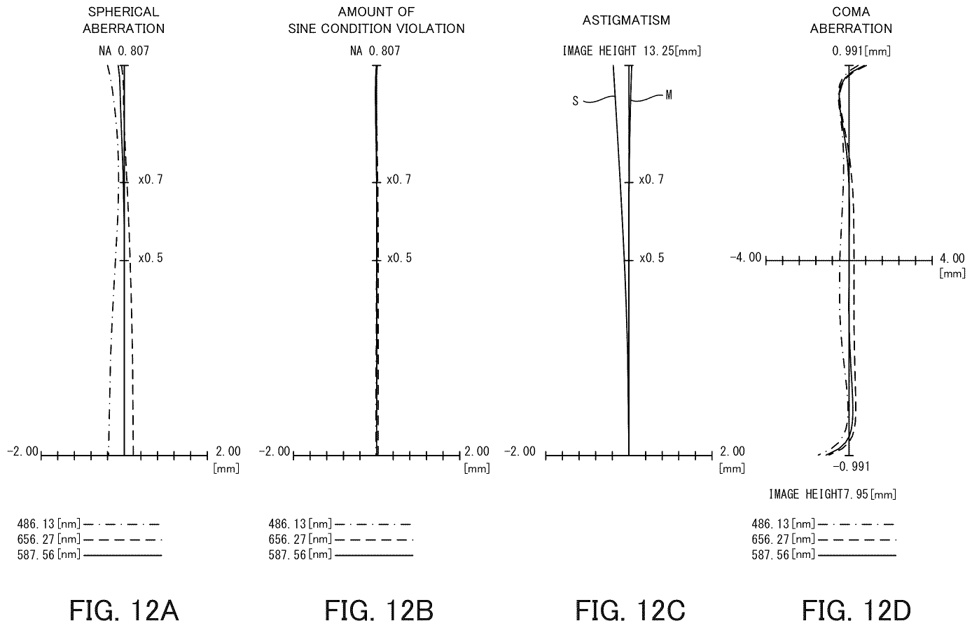

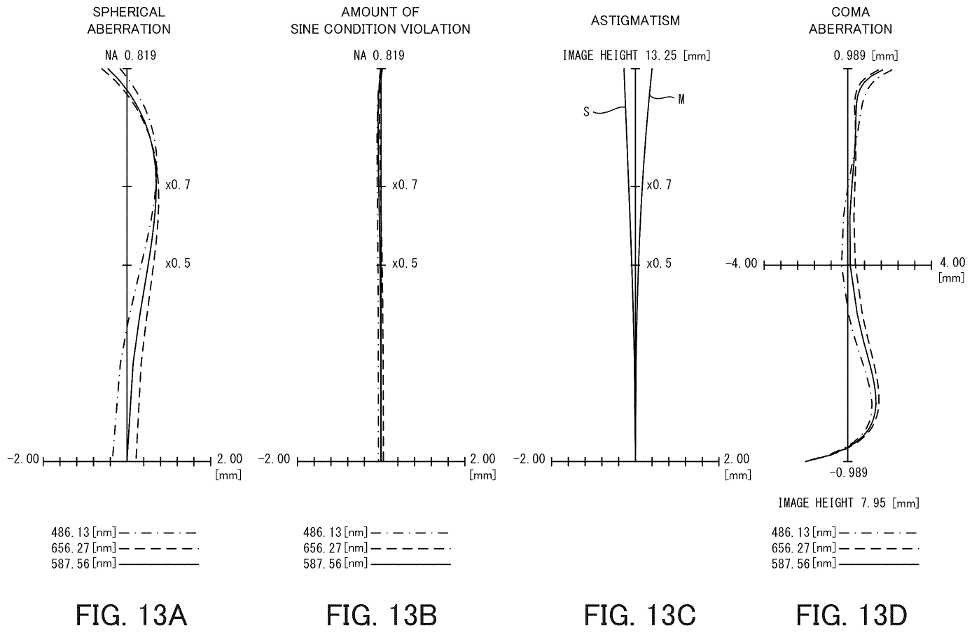

FIGS. 11A to 13D are aberration diagrams of an optical system including the objective 3 and the imaging lens 10 and illustrate aberrations at an image plane formed by the objective 3 and the imaging lens 10 in the first state, the second state, and the third state, respectively. FIGS. 11A, 12A, and 13A are spherical aberration diagrams. FIGS. 11B, 12B, and 13B are diagrams illustrating the amounts of sine condition violation. FIGS. 11C, 12C, and 13C are astigmatism diagrams. FIGS. 11D, 12D, and 13D are coma aberration diagrams at the image height ratio of 0.6 (an image height of 7.95 mm). As illustrated in FIGS. 11A to 13D, in the present example, the aberrations are favorably corrected regardless of the immersion liquid in the case of using the immersion liquid depending on a refractive index of an object.

What is claimed is:

1. An objective comprising: in order from an object side,
a first lens group that has positive refractive power and converts divergent light into convergent light;
a second lens group that is moved along an optical axis and has negative refractive power;
a third lens group that has two or more cemented surfaces; and
a fourth lens group that includes, in order from the object side,
a meniscus lens component having a convex surface facing the object side,
a lens component having a concave surface facing the object side and
a lens having a convex surface facing an image side.

2. The objective according to claim 1, wherein the number of cemented surfaces of the first lens group is smaller than the number of the cemented surfaces of the third lens group.

3. The objective according to claim 1, wherein
the first lens group includes three or more lens components, each of which has positive refractive power, and
none of the three or more lens components is a cemented lens in which a negative lens is located closer to the object side with respect to a positive lens.

4. The objective according to claim 1, wherein the first lens group includes a first lens component closest to the object side, and three or more single lenses, each of which has positive refractive power.

5. The objective according to claim 1, wherein the first lens group includes a first lens component in which a positive lens having a convex surface facing the image side and a meniscus lens having a concave surface facing the object side are cemented, the first lens component being provided closest to the object side.

6. The objective according to claim 1, wherein a following conditional expression is satisfied:
0≤D_{2G}/TL≤0.16
here, D_{2G} denotes a distance on the optical axis from a surface of the second lens group which is closest to the object side to a surface of the second lens group which is closest to the image side, and TL denotes a distance on the optical axis from a surface of the objective which is closest to the object side to a surface of the objective which is closest to the image side.

7. The objective according to claim 1, wherein the second lens group is a cemented lens component consisting of, from the object side, a negative lens and a positive lens.

8. The objective according to claim 1, wherein the fourth lens group consists of three or more lens components.

9. The objective according to claim 8, wherein the fourth lens group further includes a lens component having positive refractive power between the lens component having the concave surface facing the object side which is included in the fourth lens group and the lens having the convex surface facing the image side which is included in the fourth lens group.

10. The objective according to claim 1, wherein a following conditional expression is satisfied:
0.2≤Φ_{L}/TL≤0.6
here, Φ_{L} denotes an outer diameter of a lens which is closest to the image side.

11. The objective according to claim 2, wherein
the first lens group includes three or more lens components, each of which has positive refractive power, and
none of the three or more lens components is a cemented lens in which a negative lens is located closer to the object side with respect to a positive lens.

12. The objective according to claim 2, wherein the first lens group includes a first lens component closest to the object side, and three or more single lenses, each of which has positive refractive power.

13. The objective according to claim 2, wherein the first lens group includes a first lens component in which a positive lens having a convex surface facing the image side and a meniscus lens having a concave surface facing the object side are cemented, the first lens component being provided closest to the object side.

14. The objective according to claim 2, wherein a following conditional expression is satisfied:
0≤D_{2G}/TL≤0.16
here, D_{2G} denotes a distance on the optical axis from a surface of the second lens group which is closest to the object side to a surface of the second lens group which is closest to the image side, and TL denotes a distance on the optical axis from a surface of the objective which is closest to the object side to a surface of the objective which is closest to the image side.

15. The objective according to claim 2, wherein the second lens group is a cemented lens component consisting of, from the object side, a negative lens and a positive lens.

16. The objective according to claim 2, wherein the fourth lens group consists of three or more lens components.

17. The objective according to claim 16, wherein the fourth lens group further includes a lens component having positive refractive power between the lens component having the concave surface facing the object side which is included in the fourth lens group and the lens having the convex surface facing the image side which is included in the fourth lens group.

18. The objective according to claim 2, wherein a following conditional expression is satisfied:
0.2≤Φ_{L}/TL≤0.6
here, Φ_{L} denotes an outer diameter of a lens which is closest to the image side.

19. The objective according to claim 3, wherein the first lens group includes a first lens component closest to the object side, and three or more single lenses, each of which has positive refractive power.

20. The objective according to claim 3, wherein the first lens group includes a first lens component in which a positive lens that has a convex surface facing the image side and a meniscus lens that has a concave surface facing the object side are cemented, the first lens component being provided closest to the object side.
